(19) United States
(12) Patent Application Publication
(10) Pub. No.: US 2026/0209615 A1
(43) Pub. Date: Jul. 23, 2026

(54) REMOVAL OF NITROGEN FROM RENEWABLE PRODUCTS

(71) Applicant: TOPSOE A/S, Kgs. Lyngby (DK)

(72) Inventors: Jens Anders HANSEN, Holte (DK); Niels Christian SCHJØDT, Hvalsø (DK)

(73) Assignee: TOPSOE A/S, Kgs. Lyngby (DK)

(21) Appl. No.: 19/140,767

(22) PCT Filed: Dec. 21, 2023
(86) PCT No.: PCT/EP2023/087392

§ 371 Date: Jun. 18, 2025

(30) Foreign Application Priority Data
Dec. 22, 2022 (EP) 22215996.4

(51) Int. Cl. C10G 53/10; B01D 3/14; C02F 11/10; C10G 1/02; C10G 17/06; C10G 17/095; C10G 45/02

(52) U.S. Cl. CPC C10G 53/10; B01D 3/143; C02F 11/10; C10G 1/02; C10G 17/06; C10G 17/095; C10G 45/02; C10G 2300/1003; C10G 2300/202; C10G 2400/04; C10G 2400/08

(57) ABSTRACT

A system for processing carbonaceous in-feed material has a pyrolyzer kiln for pyrolysis the carbonaceous in-feed material, the kiln operating in a slow pyrolysis process in which the in-feed material is pyrolysed in the kiln for a period of minutes in order to produce primarily a gaseous output fraction; a steam reformer positioned downstream of the kiln to which combustion gasses from the pyrolyzer kiln are fed; a water scrubber positioned gas flow-wise downstream of the steam reformer; a methanation stage; a CO2 scrubbing stage. The system includes means for splitting the gas and directing a portion of the split gas back to the pyrolyzer kiln.

### TECHNICAL FIELD

A process is provided for reducing the nitrogen content of a renewables stream originating from a liquid renewables stream or a fraction thereof, comprising a step of treating said renewables stream or said fraction with acid. A plant for carrying out the process is also provided.

### BACKGROUND

Conversion of feedstocks based on renewables to transportation fuel such as jet fuel or diesel fuel or to steam cracker feed typically requires a step of hydroprocessing to remove or degrade O, N and S-containing species.

The jet cut originating from processing feedstocks based on renewables, such as pyrolysis oil and Hydrothermal Liquefaction (HTL) oil, has to meet a nitrogen specification of less than 2 wt ppm. It has turned out that this can be difficult to achieve by hydroprocessing alone. This is even more important with so-called “third generation” of renewable feedstocks, which include solid biomass waste (e.g., sludge, grass/straw or algae) or recycled carbon (e.g., plastic waste, municipal solid waste or refuse derived fuel), in which nitrogen content can be high (e.g. at least 100 wt ppm). The term “renewables” shall be construed to exclude fossil crudes, but to include recycled waste of fossil origin, such as plastic waste. A wide range of renewables is defined in EU Directive 2018/2001 (RED II), Annex IX, part A, and unless explicitly excluded in the following, the materials mentioned in this document shall be understood to be included in the term renewables.

The standard solution is to hydroprocess (e.g., hydrotreat) the renewables but it has turned out that very severe conditions (high pressure and high temperature in the reactor) are needed to reduce the nitrogen content to below 2 wt ppm. Such severe conditions will result in shorter cycle lengths and require high H₂ consumption and high energy consumption.

Co-pending application PCT/EP2022/079932 describes a process for conversion of a feedstock originating from thermal decomposition of solids, containing from at least 0.5 wt % nitrogen.

It is an object of embodiments of the invention to provide a process for reducing the nitrogen content of a renewables stream, e.g. a jet fuel fraction, in particular, to a nitrogen content below 2 ppm.

### SUMMARY OF THE INVENTION

It has been found by the present inventor(s) that treatment with an acid after hydroprocessing can reduce the amount of nitrogen in renewable products significantly, and to a level comparable with the specification.

So, in a first aspect the present invention relates to a process for reducing the nitrogen content of a renewables stream originating from a liquid renewables stream, said process comprising the steps of:
a. hydroprocessing a liquid renewables stream to provide an intermediate renewables stream,
b. providing a renewables stream from all of said intermediate renewables stream or optionally a fraction of said intermediate renewables stream obtained by distilling the intermediate renewables stream, and
c. treating said renewables stream or said fraction, with acid.

Furthermore, a renewables plant, is provided, said renewables plant comprising
a feedline of liquid renewables,
a hydroprocessing section arranged to hydroprocess said liquid renewables stream and provide an intermediate renewables stream,
optionally, a distillation section arranged to fractionate said intermediate renewables stream.
a source of acid,
mixing means arranged to mix the renewables stream or fraction thereof with said source of acid and provide a combined stream,
separating means arranged to separate the combined stream into a renewables stream or fraction thereof with low N content, and spent acid stream.

Further details of the technology are provided in the enclosed dependent claims and figures.

### LEGENDS TO THE FIGURES

The technology is illustrated by means of the following schematic illustration(s), in which:

FIG. 1 is a diagram showing one embodiment of the process of the invention

FIG. 2 shows the results obtained from the renewables stream experiments

### DETAILED DISCLOSURE

Nitrogen content may be measured using elemental analysis, e.g using ASTM D4629. The content is provided as atomic nitrogen (i.e. “N”), regardless of the nature of the N-containing molecule in the feedstock.

A process for reducing the nitrogen content of a renewables stream originating from a liquid renewables stream, is provided. The process comprises the general steps of:
a. hydroprocessing a liquid renewables stream to provide an intermediate renewables stream,
b. providing a renewables stream from all of said intermediate renewables stream or optionally a fraction of said intermediate renewables stream obtained by distilling the intermediate renewables stream, and
c. treating said renewables stream or said fraction, with acid.

In other words, the acid treatment can take place on a renewables stream itself, or a fraction thereof. Preferably, the renewables fraction is a jet fuel fraction, as this fraction has a strict nitrogen specification. A “jet fuel fraction” is a fraction comprising >95 wt % of components boiling in the jet range.

In an embodiment the liquid renewables stream may be characterized by its elemental composition being from 50 wt % to 70 wt %, 80 wt % or 85 wt % C and from 2 wt % 3 wt % 5 wt % or 10 wt % to 50 wt % O, which is an exemplary elemental composition range of a liquid, non-aqueous thermochemical decomposition product such as a pyrolysis oil stream or a hydrothermal liquefaction oil (HTL oil) stream.

The acid used in the acid treatment step (c) suitably has a pH of below 6, such as below 5, below 4, or below 2. The acid used may be in solid form or in the form of an aqueous solution.

Conditions for the acid treatment step (c) may e.g. be 5-110° C., such as 20-100° C. and 0-10 barg such as 2-5 barg.

In one aspect, therefore, the acid treatment step (c) comprises contacting the renewable stream or fraction thereof with an aqueous solution of an acid, preferably selected from carbonic acid, sulfuric acid, hydrochloric acid, maleic acid, acetic acid, citric acid or phosphoric acid, preferably sulfuric acid.

In a further aspect, the acid treatment step (c) comprises contacting the renewable stream or fraction thereof with a solid acid, such as an acidic material comprising zeolite or an acidic material comprising silica-alumina. The nitrogen content of the renewable stream or fraction thereof can also be reduced using other absorbents such as acidic ion exchangers like e.g. Amberlyst 15, which contains covalently bound sulfonic acid groups capable of protonating amines, which are then retained on the resin in the form of their ammonium salts. The resin can be regenerated by washing with strong acids such as dilute sulfuric acid or the like. Other absorbents are acidic metal oxides, preferably with high surface area, such as silica-alumina and zeolites as already mentioned, but also supported or unsupported acidic transition metal oxides such as Nb₂O₅ and WO₃, which can be regenerated by washing with strong acids such as dilute sulfuric acid or the like, but which can also be regenerated by calcination at a temperature at which the organic molecules are combusted, such as 500° C. Furthermore, sulfated or tungstated zirconia, phosphorylated niobia, supported phosphoric acid or P₂O₅ and the like can also be used. These materials are best regenerated by calcination.

Prior to the acid treatment step, the renewable stream or fraction thereof suitably has a N content (in wt. ppm) of at least 50, suitably at least 100.

The term “hydroprocessing” may include one or more of stabilisation, hydrometallation (HDM), hydrotreating (HDT)—including hydrodeoxygenation (HDO) and hydrodesulfurization (HDS), hydrodearomatisation (HDA), hydrocracking (HDC), and isomerization. Depending on the renewables, the catalyst and the reaction conditions, one or more of such processes may take place under the general term “hydroprocessing”. Hydroprocessing can take place in several stages with separation, washing and so on between each step. Typically, several different catalysts are used for the hydroprocessing steps, but catalysts may also be multifunctional.

One or more of the following additional steps could be carried out as part of the process of the invention:
Filtration
Bleaching
Centrifugation
Adsorption
Stabilisation
Degumming
Deacidification
Acidification
Hydrothermal treatment

Suitably, the process comprises additional steps of filtration, stabilisation and hydrometallation of the liquid renewables stream, prior to step a. It is preferred that steps a. and b. are performed sequentially, without any intermediate step(s).

The renewables may be—at least partly—in solid form. This is typical for so-called “third generation” renewables. In this case, the process may further comprise a step of thermally decomposing (e.g. pyrolyzing) said renewables, to provide the liquid renewables stream. Accordingly, the solid renewables may be converted to a feedstock comprising compounds which at moderately elevated temperatures (>80° C.) but below the temperatures resulting in substantially complete hydrotreatment may react to form larger molecules, potentially resulting in full or partial blockage of reactors, tubes, heaters, heat exchangers and catalysts. Examples of such mixtures may be feedstock rich in conjugated diolefins or styrene and its homologs from thermal decomposition of plastic waste, municipal solid waste, refuse derived fuel and solid recovered fuel, feedstock rich in carbonyls and sugars from thermal decomposition of lignocellulosic biomass and feedstock rich in nitrogen from thermal decomposition of nitrogen rich biomass, such as manure and sewage sludge, and similar composition from other sources. The reactive compounds may either react within the same functional group (diolefin with diolefin) or across functional groups (aldehyde with phenol).

The pyrolysis step may include the use of a pyrolysis unit such as fluidized bed, transported bed, or circulating fluid bed, as is well known in the art. For instance, the pyrolysis step may comprise the use of a pyrolysis unit (also referred herein as pyrolysis reactor), cyclone(s) to remove particulate solids such as char, and a cooling unit for thereby producing said first off-gas stream (i.e. pyrolysis off-gas) and said first liquid oil stream, i.e. condensed pyrolysis oil. This first off-gas stream comprises light hydrocarbons e.g. C1-C4 hydrocarbons, CO and CO₂. The first liquid oil stream is also referred to as pyrolysis oil or bio-oil and is a liquid substance rich in blends of molecules usually consisting of more than two hundred different compounds including aldehydes, ketones and/or other compounds such as furfural having a carbonyl group, resulting from the depolymerisation of products treated in pyrolysis.

One option is fast pyrolysis, also referred in the art as flash pyrolysis. Fast pyrolysis means the thermal decomposition of a solid renewable feedstock in the absence of oxygen, at temperatures in the range 350-650° C. e.g. about 500° C. and reaction times of 10 seconds or less, e.g. below 10 seconds, such as 5 seconds or less, e.g. about 2 seconds; i.e. the vapor residence time is 10 seconds or below, such as 2 seconds or less e.g. about 2 seconds. Traditionally, fast pyrolysis may for instance also be conducted by autothermal operation e.g. in a fluidized bed reactor. The latter is also referred as autothermal pyrolysis and is characterized by employing air, optionally with an inert gas or recycle gas, as the fluidizing gas, or by using a mixture of air and inert gas or recycle gas. Thereby, the partial oxidation of pyrolysis compounds being produced in the pyrolysis reactor (autothermal reactor) provides the energy for pyrolysis while at the same time improving heat transfer. For details about autothermal pyrolysis, reference is given to e.g. “Heterodoxy in Fast Pyrolysis of Biomass” by Robert Brown: https://dx.doi.org/10.1021/acs.energyfuels.0c03512

Thus, in an embodiment of the present application, the use of autothermal pyrolysis. i.e. autothermal operation, as a particular embodiment for conducting fast pyrolysis, is provided, i.e. the pyrolysis step is conducted by autothermal pyrolysis.

There are several types of fast pyrolysis where a catalyst is used. Sometimes an acid catalyst, such as a zeolite catalyst, is used in the pyrolysis unit (pyrolysis reactor) to upgrade the pyrolysis vapors; this technology is called catalytic fast pyrolysis (CFP) and can both be operated in an in-situ mode (the catalyst is located inside the pyrolysis unit), and an ex-situ mode (the catalyst is placed in a separate reactor; i.e. the pyrolysis gas is sent to a deoxygenation (DO) reactor for catalytically deoxygenating it prior to condensation of a pyrolysis oil, as described farther above). More specifically, in in-situ catalytic fast pyrolysis the catalyst is located inside the pyrolysis unit and the deoxygenation (through e.g. decarbonylation, decarboxylation by an acid-based catalyst such as a zeolite catalyst) takes place inside the pyrolysis reactor immediately after the pyrolysis vapours are formed. Suitable catalysts for CFP include alumina and all the types of zeolite catalysts that are normally used for hydrocracking (HCR) and cracking in refinery processes, such as HZSM-5. A more extensive list of catalytic material for HCR is provided further below in the present application.

Similarly, in in-situ HDO (also called reactive catalytic fast pyrolysis, RCFP), a hydrotreating (HDO) catalyst is located in the pyrolysis unit, and the pyrolysis vapors are thereby hydrodeoxygenated immediately in the pyrolysis reactor after they are formed. Suitably catalysts for HDO are metal-based catalysts, including reduced Ni, Mo, Co, Pt, Pd, Re, Ru, Fe, such as CoMo or NiMo catalysts, suitably also in sulfide form: CoMOS, NiS, NiMOS, NiWS, RuS. When a catalyst is “based” on a particular metal (e.g. Ni-based), this means that that amount of the listed metal(s) Ni, Mo, . . . is at least 90 wt %, 99% or 100% of the Group 1-12 materials in the catalyst. The following ranges for each category is provided: Ni-based (2-30 wt % Ni sulfided or reduced), Mo-based (2-30 wt % Mo preferably sulfided), CoMo-based (1-10 wt % Co, 2-30 wt % Mo preferably sulfided), NiMo-based (1-10 wt % Ni, 2-30 wt % Mo preferably sulfided), W-based (2-30 wt % W preferably sulfided), NiW-based (1-10 wt % Ni, 2-30 wt % W preferably sulfided) or Ru-based (0.1-10 wt % preferably reduced), optionally in sulfided or reduced form.

The catalyst supports may be the same in conventional HDO in refinery processes, typically a refractory support such as alumina, silica or titania, or combinations thereof. Further below in the present application, HDO conditions are also recited.

In ex-situ deoxygenation (DO), the vapors are deoxygenated in a separate DO reactor located after the pyrolysis unit. Thus, in ex-situ catalytic fast pyrolysis, the vapors are deoxygenated using an acid catalyst, such as a zeolite catalyst.

In ex-situ HDO, the pyrolysis vapors are hydrodeoxygenated in a separate HDO reactor located after the pyrolysis reactor using a hydrotreating catalyst.

The use of a catalyst in the pyrolysis reactor conveys the advantage of lowering the activation energy for reactions thereby significantly reducing the required temperature for conducting the pyrolysis. In addition, increased selectivity towards desired pyrolysis oil compounds may be achieved.

It would be understood that where hydrogen is added to the catalytic fast pyrolysis, it is called reactive catalytic fast pyrolysis (RCFP). Further, if the catalytic fast pyrolysis is conducted at a high hydrogen pressure (^{~}>5 barg) it is often called catalytic hydropyrolysis (CHP). Hydropyrolysis (HP) means that hydrogen is added to the pyrolysis, yet at atmospheric pressure.

The pyrolysis step is suitably also a simple fast pyrolysis, which for the purposes of this application means fast pyrolysis being conducted without the presence of a catalyst and hydrogen in the pyrolysis unit, i.e. the fast pyrolysis is not any of: catalytic fast pyrolysis (CFP), hydropyrolysis (HP), reactive catalytic fast pyrolysis (RCFP) or catalytic fast hydropyrolysis (CHP). The pyrolysis unit may not include a HDO reactor downstream. This enables a much simpler and inexpensive process.

The table below summarizes the different options for fast pyrolysis apart from autothermal pyrolysis:

| | | | HDO | DO |
|---|---|---|---|---|
| | Hydrogen | Catalyst | within or | within or |
| Fast | added to | within | outside | outside |
| pyrolysis | pyrolysis | pyrolysis | pyrolysis | pyrolysis |
| type | unit | unit | unit | unit |
| Simple fast | no | no | outside | no |
| pyrolysis | | | (ex-situ | |
| | | | HDO) | |
| Simple fast | no | no | No | no |
| pyrolysis | | | | |
| in-situ CFP | no | yes (acid | No | Inside |
| | | catalyst) | | |
| ex-situ CFP | no | no | No | outside |
| | | | | (ex-situ |
| | | | | DO) |
| RCFP | yes | yes | Inside | no |
| (in-situ | | (HDO | | |
| HDO) | | catalyst) | | |
| HP | yes | yes/no | Outside | outside |
| CHP | yes, at | As for | As for | As for |
| | high H₂ | RCFP, | RCFP, | RCFP, |
| | pressure | HP | HP | HP |
| | (>5 barg) | | | |

Accordingly, in an embodiment the pyrolysis step is fast pyrolysis, in which the vapor residence time is 10 seconds or less, e.g. below 10 seconds, such as 5 seconds or less, e.g. about 2 seconds, or 1 second, or in the range 1-5 seconds, and which is selected from: simple fast pyrolysis; in-situ catalytic fast pyrolysis (in-situ CFP); ex-situ catalytic fast pyrolysis (ex-situ CFP); reactive catalytic fast pyrolysis (RCFP); hydropyrolysis (HP); catalytic fast hydropyrolysis (CHP).

In another embodiment, the pyrolysis step is intermediate pyrolysis, in which the vapor residence time is in the range of 10 seconds-5 minutes, such as 11 seconds-3 minutes. As for fast pyrolysis, the temperature is also in the range 350-650° C. e.g. about 500° C. Often this pyrolysis is conducted in pyrolysis reactors handling different types of waste, where the vapor is burned after the pyrolysis reactor. Typical reactors are: Herreshoff furnace, rotary drums, amaron, CHOREN paddle pyrolysis kiln, auger reactor, and vacuum pyrolysis reactor.

In another embodiment, the pyrolysis step is slow pyrolysis, in which the solid residence time is in the range of 5 minutes-2 hours, such as 10 min-1 hour. The temperature is suitably about 300° C. This pyrolysis gives a high char yield and the char can be used as a fertilizer or as char coal; the pyrolysis still produces some gas and renewable crude and if the carbon is used a fertilizer the final bio-oil can have a GHG above 100%, thus being carbon negative. Typical reactors are auger reactor (yet with a different residence time than for intermediate pyrolysis), fixed bed reactor, kiln, lambiotte SIFIC/CISR retort, Lurgi process, wagon reactor, and carbo twin resort.

In an embodiment, the pyrolysis step further comprises a preliminary step of passing said solid renewable feedstock through a solid renewable feedstock preparation section comprising for instance drying for removing water and/or comminution for reduction of particle size. Any water/moisture in the solid renewable feedstock which vaporizes in for instance the pyrolysis section condenses in the pyrolysis oil stream and is thereby carried out in the process, which may be undesirable. Furthermore, the heat used for the vaporization of water withdraws heat which otherwise is necessary for the pyrolysis. By removing water and also providing a smaller particle size in the solid renewable feedstock the thermal efficiency of the pyrolysis step is increased.

The preliminary step may also comprise conducting an acid wash for removing metals. This is particularly relevant for pyrolysis processes where the catalyst is located in the pyrolysis reactor. The removal of metals from the solid renewable feedstock increases the catalyst lifetime, but an acid wash prior to hydrotreatment may cause a loss of oxygenates with the aqueous phase.

The process of the present invention allows “deep” or “severe” hydroprocessing steps to be reduced or even eliminated. Suitably, therefore, the hydroprocessing step takes place at a pressure of around 20-200 bar H₂ and a temperature of 200-425° C., preferably 200-400° C. and at a gas to oil ratio of 500-10000 NL/L. In this step heteroatoms will be removed, including oxygen, nitrogen and sulfur, in amounts depending on the reactivity of the compounds present.

The hydroprocessing step (a) should produce a product with a nitrogen content below e.g. 2000, 500, 200, 100, 50, 20 wt ppm nitrogen. The subsequent acid treatment (step c) would result in a renewables stream or renewables fraction having a nitrogen content meeting a given nitrogen specification (e.g. jet fuel having a nitrogen content not higher than 2 wt ppm).

The hydroprocessing step (a) may be configured to involve a first hydroprocessing step, followed by withdrawal of a gas phase comprising ammonia, and a second hydroprocessing step to provide said intermediate renewables stream. Such a two stage process will have the benefit of the second hydroprocessing step being increasingly efficient, due to the muxhg lowered levels of gas phase nitrogen, which is believed to benefit due to the reaction equilibrium as well as by avoiding a partial catalyst passivation from alkaline nitrogen.

The advantages of introducing an acid treatment downstream the hydroprocessing step is that the immiscible two-phase combination of jet fuel fraction and aqueous acid solution is well defined. The absence of more polar organic molecules (e.g., containing O atoms) which in the jet fuel fraction avoids potential interference in the separation process and/or avoids a less clear interface between the two phases. Also, performing an acid treatment on a non-hydroprocessed renewables stream would lead to a greater loss of renewables into the aqueous acid phase, as at least a portion of the N, O, or S-containing polar components will enter the aqueous phase (cf. Haider, Fuel, Volume 334, Part 2, 15 Feb. 2023, 126755). Hence, treatment with acid is attractive if the liquid renewables stream is hydroprocessed to such degree that a two-phase system will form when the liquid renewables stream is mixed with aqueous acid.

In an aspect of the process—after step (c)—the acid is separated from the renewables stream or the fraction thereof, preferably, at least a portion of the acid is recycled to step (c). The acid may be subjected to an upgrading step before being recycled. Additional fresh acid may be added to the recycle step, and/or a portion of the spent acid may be removed.

The process provides a renewables stream or fraction thereof, with reduced N content. The treated renewables stream or fraction thereof has a N content (in wt. ppm) of 5 or less, suitably 3 or less, more suitably 2 or less after the acid treatment step. Suitably, the lower limit of N content is 1 wt ppb. Repeating the acid treatment step will provide a lower N content.

A renewables plant is also provided. The plant comprises:
a feedline of liquid renewables,
a hydroprocessing section arranged to hydroprocess said liquid renewables stream and provide an intermediate renewables stream,
optionally, a distillation section arranged to fractionate said intermediate renewables stream,
a source of acid,
mixing means arranged to mix the renewables stream or fraction thereof with said source of acid and provide a combined stream,
separating means arranged to separate the combined stream into a renewables stream or fraction thereof with low N content, and spent acid stream.

Suitably mixing means may be a static mixer. Suitable separating means for separating the combined stream may be a liquid-liquid separation vessel where the two immiscible liquid phases separate by the difference in density of the liquids. The organic phase may also have a fraction with density above acid and a fraction with density below, such that three phases must be separated.

### Specific Embodiments

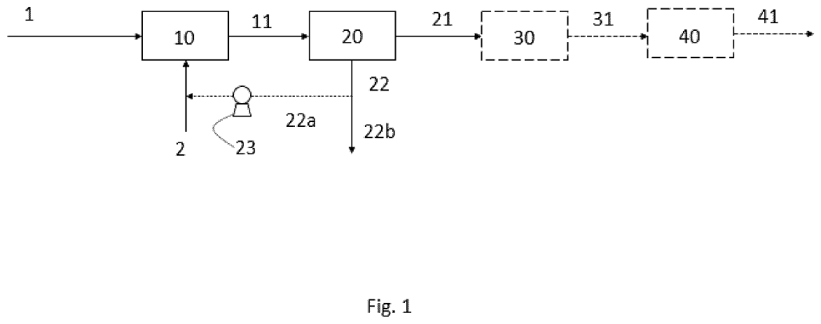

In the layout of FIG. 1, jet fuel fraction 1 originating from a liquid renewables stream is mixed with acid 2 in mixing vessel 10, which may e.g. be a static mixer. Acid 2 is—in this embodiment—in the form of an aqueous solution of sulfuric acid, which forms an immiscible two-phase combination with the jet fuel fraction 1. The combined stream 11 of jet fuel fraction 1 and acid 2 is sent to separating unit 20, (which may e.g. be a settling tank or a phase separator vessel) where it is separated into a jet fuel fraction with low N content 21, and spent acid stream 22. The heavy phase is the aqueous phase (spent sulfur acid solution) and the light phase is the treated oil.

Optionally, the jet fuel fraction 21 is washed with water in water-wash section 30 after the acid treatment, so that excess acid can be removed. The treated product 31 is routed to a drier 40 for removal of any left-over water, and so as to output a dried jet fraction 41 with low N content.

A first portion 22a of the spent acid stream 22 may be recycled to mixing unit 10, with optionally one or more steps of upgrading and/or regenerating the spent acid stream in between. A pump 23 may be situated in the recycle line. A second portion 22b of the acid may be taken out and new acid may be added as required.

Although the present invention is described with reference to a number of aspects and embodiments, the skilled person may combine such aspects and embodiments, within the scope of the appended claims. All documents referenced herein are incorporated by reference.

### EXAMPLES

### 1 Non-Catalytic Removal of Nitrogen

As mentioned above, it has proven difficult to reduce the content of nitrogen in a jet fraction originating from thermal decomposition to below 2 wt ppm as required by the ASTM standard. It was found that reduction of nitrogen required severe conditions in the hydroprocessing to achieve this low nitrogen level.

Alternative ways for removal of nitrogen were studied. In the first experiment a diesel product was investigated by three different procedures. The diesel product was a fraction originating from hydroprocessing of liquid renewables produced by thermal decomposition of solid renewables.

In a first experiment a product from pyrolysis of sewage sludge was the liquid renewable starting material. This first liquid renewable starting material contained 9.1 wt % nitrogen, 1 wt % sulfur and 7.6 wt % oxygen and had a specific gravity of 1.0098. After stabilization at 220° C. and 120 barg, the stabilized renewable material was directed to a severe hydrotreatment using an active catalyst, operating at 340-375° C., 120 barg, LHSV of 0.5 h⁻¹ and 4100 NI/I hydrogen to oil ratio. The liquid fraction of the resulting first experiment initial intermediate renewable material comprised 4131 wt ppm nitrogen, 608 wt ppm sulfur and 7460 wt ppm oxygen and specific gravity was reduced to 0.8414. The process off-gas was rich in ammonia and directed to waste.

The liquid fraction of the resulting first experiment initial intermediate renewable material was directed to a further hydrotreating step. at a pressure of 151 barg and a reactor temperature of 325° C. using a hydrogen to oil ratio of 2200 NI/I and a LHSV of 0.58 h⁻¹. This first experiment final intermediate renewable material was fractionated and the nitrogen content of the diesel fraction was 203.7 wt ppm.

### Experiment 1. Treatment with Sulfuric Acid

In this experiment 30 ml of the final intermediate renewable diesel fraction (organic solution) was contacted with 30 ml 10% sulfuric acid solution (aqueous solution). The combined sample was transferred to a laboratory scale separation funnel. The funnel was then closed and shaken at room temperature for a few minutes to contact the organic solution with the sulfuric acid solution. The funnel was then set aside for the complete separation of the oil phase and the aqueous phase. When the separation was completed the lower phase (aqueous phase) was removed from the bottom and put into a sample container. The organic phase was taken out from the top in another sample container. The organic phase was then dried by contact with 5 grams of magnesium sulfate MgSO₄ powder and then shaken. The MgSO₄ was then removed from the mixture by filtering.

### 1.1 Experiment 2. Treatment with Extrudates Containing Y-Zeolite

In this experiment 25 g of product sample (final intermediate renewable diesel fraction) was contacted with 5 g of extrudates with a content of 40 wt % zeolite Y and 60 wt % alumina for 1 hour at room temperature. After this treatment the extrudates were removed by filtering.

### 1.2 Experiment 3. Treatment with Silica-Alumina Powder

This experiment was similar to experiment 2 but instead of the use of extrudates 5 g of silica-alumina powder from Merck was used.

### 1.3 Discussion of Experiment 1, 2 and 3

A diesel sample obtained from thermal decomposition of sewage sludge followed by deep hydrotreatment, having a nitrogen content of 203.7 wt ppm was treated by the three procedures mentioned above. The nitrogen content of the treated product from experiment 1, 2 and 3 was compared with the non-treated sample as shown in Table 1.

It was found that a significant lower nitrogen content was obtained in the three treated samples. The samples treated with sulfuric acid and silica-alumina were found to have a nitrogen content of about 2 wt ppm.

TABLE 1
Treatment of diesel sample. Experiment 1, 2, and 3.

| | | | Sample | Sample | Sample |
|---|---|---|---|---|---|
| | | | from | from | from |
| | | Original | experiment | experiment | experiment |
| | | sample | 1 | 2 | 3 |
| Nitrogen, | D | 203.7 | 2.0 | 140.5 | 2.1 |
| wt ppm | 4629 | | | | |

Corresponding results would be expected for a jet fuel fraction.

### Renewables Stream Experiments

A renewables stream was hydroprocessed according to step (a) using a hydroprocessing catalyst. The pressure and temperature in the reactor were varied and samples were taken. Some of the samples were fractionated into fractions.

In this second experiment a second product from pyrolysis of sewage sludge was the liquid renewable starting material. This second experiment liquid renewable starting material contained 8.7 wt % nitrogen, 0.8 wt % sulfur and 6.3 wt % oxygen and had a specific gravity of 1.0004. After stabilization at 220° C. and 120 barg, the stabilized renewable material was directed to a severe hydrotreatment using an active catalyst, operating at 360-400° C., 71 barg, LHSV of 0.5 h⁻¹ and 4200 NI/I hydrogen to oil ratio. The resulting second experiment initial intermediate renewable material comprised 6443 wt ppm nitrogen, 153 wt ppm sulfur and 5930 wt ppm oxygen and specific gravity was reduced to 0.8537.

The second experiment initial intermediate renewable material (absent off-gases) was treated at a reactor temperature of 380° C., a pressure of 71 barg, LHSV of 0.5 h⁻¹ and 2400 NI/I hydrogen to oil ratio to provide Sample A. The product nitrogen content was 245.8 wt ppm before being treated as described in experiment 1. The nitrogen content after treatment was found to be reduced to 96 wt ppm.

The second experiment initial intermediate renewable material (absent off-gases) was treated at a reactor temperature of 380° C., pressure of 122 barg, LHSV of 0.5 h⁻¹ and 2400 NI/I hydrogen to oil ratio and was fractionated to provide the jet fuel fraction as Sample B. The jet fuel fraction had a content of 0.6 wt ppm nitrogen. Treatment of this fraction as described in experiment 1 resulted in a nitrogen content of 0.1 wt ppm.

The second experiment initial intermediate renewable material (absent off-gases) was treated at a reactor temperature of 360° C., a reactor pressure of 122 barg, LHSV of 0.5 h⁻¹ and 2400 NI/I hydrogen to oil ratio to provide Sample E. Sample E was fractionated into a jet fuel fraction (sample D) and a diesel fuel fraction (sample C). The samples A, B, C, D and E were all treated with sulfuric acid (1:1 vol with 10 wt % sulfuric acid) as described in experiment 1. The nitrogen content of the treated samples was found to be significantly lower than that of the original sample.

The experiments showed that the acid treatment reduced the nitrogen content significantly, allowing less severe reactor temperature and/or pressure to be used in the hydroprocessing process.

| | | A | B | C | D | E |
|---|---|---|---|---|---|---|
| | | Bio- | Biofuel | Biofuel | Biofuel | Bio- |
| | Sam- | fuel | Jet | Diesel | Jet | fuel |
| | ple | stream | fraction | fraction | fraction | stream |
| 2^{nd} reactor | | 380 | 380 | 360 | 360 | 360 |
| temperature | | | | | | |
| 2^{nd} reactor pressure | barg | 71 | 122 | 122 | 122 | 122 |
| Nitrogen content | wt | 245.8 | 0.6 | 31.8 | 49.2 | 31.2 |
| HDT only | ppm | | | | | |
| Nitrogen content | wt | 96 | 0.1 | 4.5 | 4.2 | 7.6 |
| HDT and | ppm | | | | | |
| Acid treated | | | | | | |

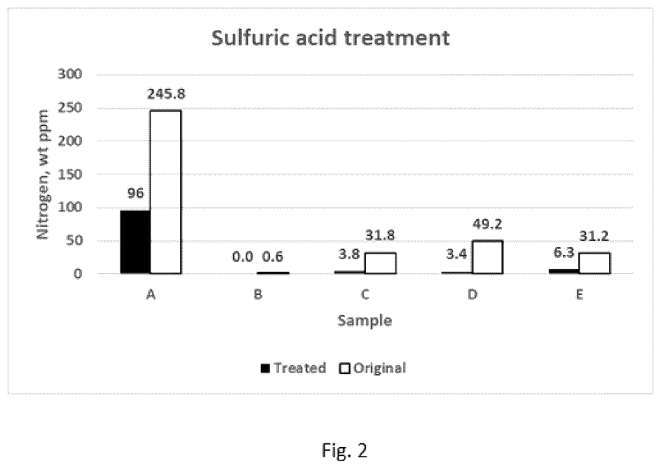

The result of the treatment is shown in FIG. 2 where the original (hydrotreated, but without sulfuric acid treatment) and treated (sulfuric acid treated) samples are shown pairwise. It is clearly seen that the nitrogen content is significantly reduced in the treated samples.

1. A process for reducing the nitrogen content of a renewables stream, the renewables stream originating from a liquid renewables stream, said process comprising the steps of:
a. hydroprocessing said liquid renewables stream to provide an intermediate renewables stream,
b. providing a renewables stream from all of said intermediate renewables stream, or from a fraction of said intermediate renewables stream obtained by distilling the intermediate renewables stream, and
c. treating said renewables stream in liquid state, with an acid.

2. The process according to claim 1, wherein the renewables stream is provided from the fraction, wherein the fraction is a jet fuel fraction.

3. The process according to claim 1, wherein the acid used in the step (c) has a pH of below 6.

4. The process according to claim 1, wherein the step (c) comprises contacting said renewables stream with an aqueous solution of an acid.

5. The process according to claim 1, wherein the step (c) comprises contacting said renewables stream with a solid acid.

6. The process according to claim 1, in which said step (a) involves a first hydroprocessing step, withdrawal of a gas phase comprising ammonia, and a second hydroprocessing step to provide said intermediate renewables stream.

7. The process according to claim 1, wherein the step (a) is one or more processes selected from stabilisation, hydrometallation (HDM), hydrodearomatisation (HDA), hydrocracking, isomerization, and hydrotreating.

8. The process according to claim 1, wherein the process further comprises a step of thermally decomposing a renewable material at least partly in solid form, to provide the liquid renewables stream.

9. The process according to claim 8, wherein the solid renewable material comprises one or more of
a lignocellulosic biomass including: wood products, algae, grass, forestry waste, sewage sludge, and agricultural residue; and/or
municipal waste.

10. The process according to claim 1, wherein, after the step (c), the acid is separated from the renewables stream.

11. The process according to claim 1, wherein the hydroprocessing of the step (a) takes place at a pressure of around 20-200 bar H₂, a temperature of 200-425° C., and a gas to oil ratio of 500-10000 NL/L.

12. The process according to claim 1, wherein the hydroprocessing of the step (a) produces a product with a nitrogen content below 200 wt ppm nitrogen.

13. The process according to claim 1, wherein the renewables stream has a N content (in wt. ppm) of 5 or less after the acid treatment step.

14. A renewables plant, said renewables plant comprising
a feedline of liquid renewables,
a hydroprocessing section arranged to hydroprocess said liquid renewables stream and provide an intermediate renewables stream,
optionally, a distillation section arranged to fractionate said intermediate renewables stream,
a source of acid,
mixing means arranged to mix the intermediate renewables stream or a fraction thereof with said source of acid and provide a combined stream, and
separating means arranged to separate the combined stream into a renewables stream or fraction thereof with low N content, and a spent acid stream.

15. The process according to claim 1, wherein the liquid renewables stream comprises at least 100 wt ppm nitrogen and originates from solid biomass waste or recycled carbon.

16. A renewables plant, said renewables plant comprising
a feedline for solid renewables,
a thermal decomposition section, arranged to receive solid renewables from said feedline of solid renewables, and for providing a liquid renewables stream,
a hydroprocessing section arranged to hydroprocess said liquid renewables stream and provide an intermediate renewables stream,
optionally, a distillation section arranged to fractionate said intermediate renewables stream,
a source of acid,
mixing means arranged to mix the intermediate renewables stream or a fraction thereof with said source of acid and provide a combined stream, and
separating means arranged to separate the combined stream into a renewables stream or fraction thereof with low N content, and a spent acid stream.
